(19) United States
(12) Patent Application Publication
(10) Pub. No.: US 2006/0239347 A1
(43) Pub. Date: Oct. 26, 2006

(54) Method and system for scene change detection in a video encoder

(76) Inventor: Ashish Koul, Cambridge, MA (US)

Correspondence Address: MCANDREWS HELD & MALLOY, LTD, 500 WEST MADISON STREET, SUITE 3400, CHICAGO, IL, 60661, US

(21) Appl. No.: 11/113,706

(22) Filed: Apr. 25, 2005

(51) Int. Cl. H04N 7/12; H04N 11/04; H04N 5/14; H04B 1/66; H04N 9/64; H04N 11/02

(52) U.S. Cl. 375/240.12; 348/700; 375/240.24; 375/240.15

(57) ABSTRACT

Described herein is a method and system for rate estimation in a video encoder. The method and system use a motion estimation metric to determine the position of a scene change. The average of the motion estimation metric is computed for a set of pictures. When change in the motion estimation metric average exceeds a threshold, a scene change is declared. Declaration of a scene change prior to video encoding enables a corresponding bit allocation that can preserve perceptual quality.

### RELATED APPLICATIONS

[Not Applicable]

### FEDERALLY SPONSORED RESEARCH OR DEVELOPMENT

[Not Applicable]

### [MICROFICHE/COPYRIGHT REFERENCE]

[Not Applicable]

### BACKGROUND OF THE INVENTION

Video communications systems are continually being enhanced to meet requirements such as reduced cost, reduced size, improved quality of service, and increased data rate. Many advanced processing techniques can be specified in a video compression standard. Typically, the design of a compliant video encoder is not specified in the standard. Optimization of the communication system's requirements is dependent on the design of the video encoder. An important aspect of the encoder design is rate control.

The video encoding standards can utilize a combination of encoding techniques such as intra-coding and inter-coding. Intra-coding uses spatial prediction based on information that is contained in the picture itself. Inter-coding uses motion estimation and motion compensation based on previously encoded pictures.

For all methods of encoding, rate control can be important for maintaining a quality of service and satisfying a bandwidth requirement. Instantaneous rate, in terms of bits per frame, may change over time. An accurate up-to-date estimate of rate must be maintained in order to control the rate of frames that are to be encoded.

Limitations and disadvantages of conventional and traditional approaches will become apparent to one of ordinary skill in the art through comparison of such systems with the present invention as set forth in the remainder of the present application with reference to the drawings.

### BRIEF SUMMARY OF THE INVENTION

Described herein are system(s) and method(s) for rate estimation while encoding video data, substantially as shown in and/or described in connection with at least one of the figures, as set forth more completely in the claims.

These and other advantages and novel features of the present invention will be more fully understood from the following description.

### BRIEF DESCRIPTION OF THE DRAWINGS

FIG. 1A is a flow diagram for detecting a scene change in accordance with an embodiment of the present invention;

FIG. 1B is a block diagram describing an exemplary video sequence in accordance with an embodiment of the present invention;

FIG. 2 is a block diagram of an exemplary system with a scene change detector in accordance with an embodiment of the present invention;

FIG. 3A is a display order of pictures in accordance with an embodiment of the present invention;

FIG. 3B is an encoding order of pictures in accordance with an embodiment of the present invention;

FIG. 4A is a graph of SAD values over time in accordance with an embodiment of the present invention;

FIG. 4B is a graph of a change in SAD values over time in accordance with an embodiment of the present invention;

FIG. 5 is a block diagram of an exemplary picture in the H.264 coding standard in accordance with an embodiment of the present invention;

FIG. 6 is a block diagram describing spatially encoded macroblocks in accordance with an embodiment of the present invention;

FIG. 7 is a block diagram of an exemplary video encoding system in accordance with an embodiment of the present invention; and

FIG. 8 is another flow diagram of an exemplary method for scene change detection in accordance with an embodiment of the present invention.

### DETAILED DESCRIPTION OF THE INVENTION

According to certain aspects of the present invention, a system and method for scene change detection in a video encoder are presented. By taking advantage of redundancies in a video stream, video encoders can reduce the bit rate while maintaining the perceptual quality of the picture. The reduced bit rate will save memory in applications that require storage such as DVD recording, and will save bandwidth for applications that require transmission such as HDTV broadcasting. Bits can be saved in video encoding by reducing space and time redundancies. Spatial redundancies are reduced when one portion of a picture can be predicted by another portion of the same picture.

Time redundancies are reduced when a portion of one picture can be predicted by a portion of another picture. When the motion in a scene is more static, more bits can be saved through motion estimation and compensation. After a scene changes, previous pictures are less able to predict a current picture. Therefore, the beginning of a scene can require a greater instantaneous bit allocation. By detecting scene changes early in the encoding process, this allocation of bits can be made to smooth the perceived transition in the video sequence, while maintaining an average bit rate.

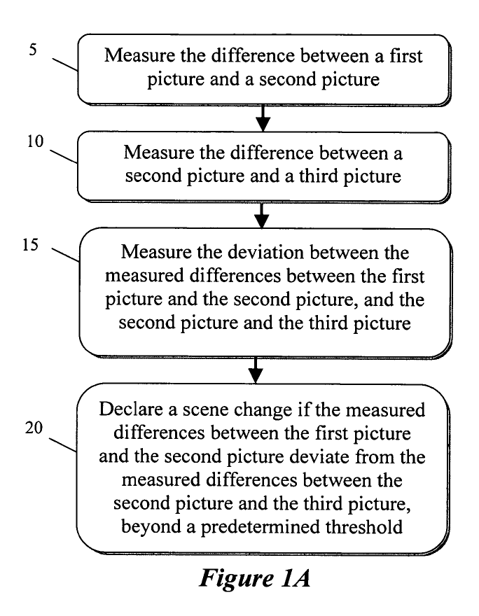

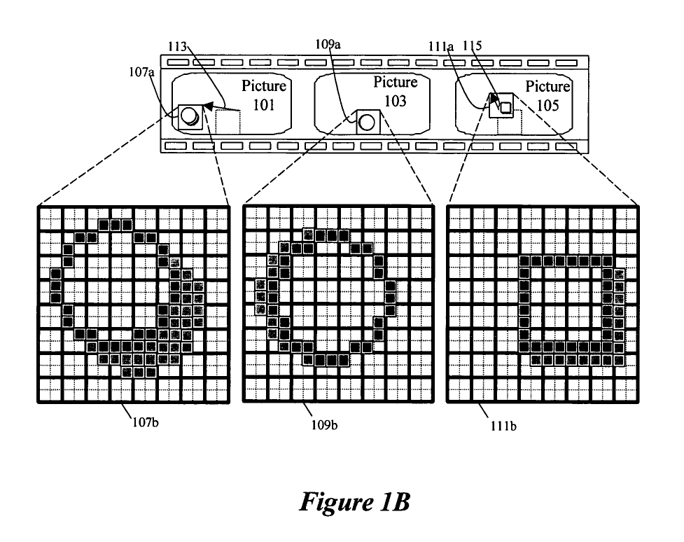

Referring now to FIG. 1A, there is illustrated a flow diagram for detecting a scene change. The flow diagram will be described in conjunction with FIG. 1B that is an exemplary video sequence. At 5, the differences between a first picture 101 and a second picture 103 are measured. At 10, the differences between the second picture 103 and a third picture 105 are measured.

The first picture 101 and the second picture 103 can be, but do not necessarily have to be, adjacent to each other. In certain embodiments, the first picture 101 and the second picture 103 can additional pictures, therebetween. For example, in certain standards, such as MPEG-2, VC-1, and Advanced Video Coding (AVC) (also known as MPEG-4, Part 10, and H.264), pictures can be encoded in a different order from the display order. Accordingly, the first picture 101 and the second picture 103 can be, but do not necessarily have to be, adjacent in the encoding order. The foregoing is also applicable to the second picture 103 and the third picture 105.

Additionally, although the illustration illustrates the first picture 101 as being the first picture in the video sequence, the second picture 103 being the second picture as second in the video sequence, and the third picture 105 as the third in the video sequence, the first picture 101, second picture 103, and third picture 105 do not necessarily have to be in the foregoing order, and can be in any order in the video sequence.

The differences between the first picture 101 and the second picture 103, and the differences between the second picture 103 and the third picture 105 can be measured in a wide variety of ways. For example, in many compression standards, such as MPEG-2, VC-1, and AVC, motion estimation is used to compress the pictures. In certain embodiments of the present invention, sets of motion estimation metrics can be calculated to measure the differences between the first picture 101 and second picture 103, and the second picture 103, and the third picture 105.

At 15, the deviation between the measured differences between the first picture 101 and the second picture 103, and the second picture 103 and the third picture 105 is measured. The deviation can be calculated by subtracting the measured differences between the first picture 101 and second picture 103, from the measured differences between the second picture 103 and third picture 105, or vice versa.

At 20, a scene change is declared if the measured differences between the first picture and the second picture deviate from the measured differences between the second picture and the third picture, beyond a predetermined threshold.

The predetermined threshold can be calculated in a variety of ways. For example, the predetermined threshold can be calculated empirically, such as by using pictures that are known to include a scene change.

The sequence of pictures 101, 103, and 105 in FIG. 1B can also be used to describe motion estimation. A portion 109a in a current picture 103 can be predicted by a portion 107a in a previous picture 101 and a portion 111a in a future picture 105. Motion vectors 113 and 115 give the relative displacement from the portion 109a to the portions 107a and 111a respectively.

The quality of motion estimation is given by a cost metric. Referring now to the portions in detail 107b, 109b, and 111b. The cost of predicting can be the sum of absolute difference (SAD). The detailed portions 107b, 109b, and 111b are illustrated as 16×16 pixels. Each pixel can have a value—for example 0 to 255. For each position in the 16×16 grid, the absolute value of the difference between a pixel value in the portion 109b and a pixel value in the portion 107b is computed. The sum of these positive differences is a SAD for the portion 109a in the current picture 103 based on the previous picture 101. Likewise for each position in the 16×16 grid, the absolute value of the difference between a pixel value in the portion 109b and a pixel value in the portion 111b is computed. The sum of these positive differences is a SAD for the portion 109a in the current picture 103 based on the future picture 105.

FIG. 1B also illustrates an example of a scene change. In the first two pictures 101 and 103 a circle is displayed. In the third picture 105 a square is displayed. The SAD for portion 107b and 109b will be less than the SAD for portion 111b and 109b. This increase in SAD can be indicative of a scene change that may warrant a new allocation of bits.

Motion estimation may use a prediction from previous and/or future pictures. Unidirectional coding from previous pictures allows the encoder to process pictures in the same order as they are presented. In bidirectional coding, previous and future pictures are required prior to the coding of a current picture. Reordering in the video encoder is required to accommodate bidirectional coding.

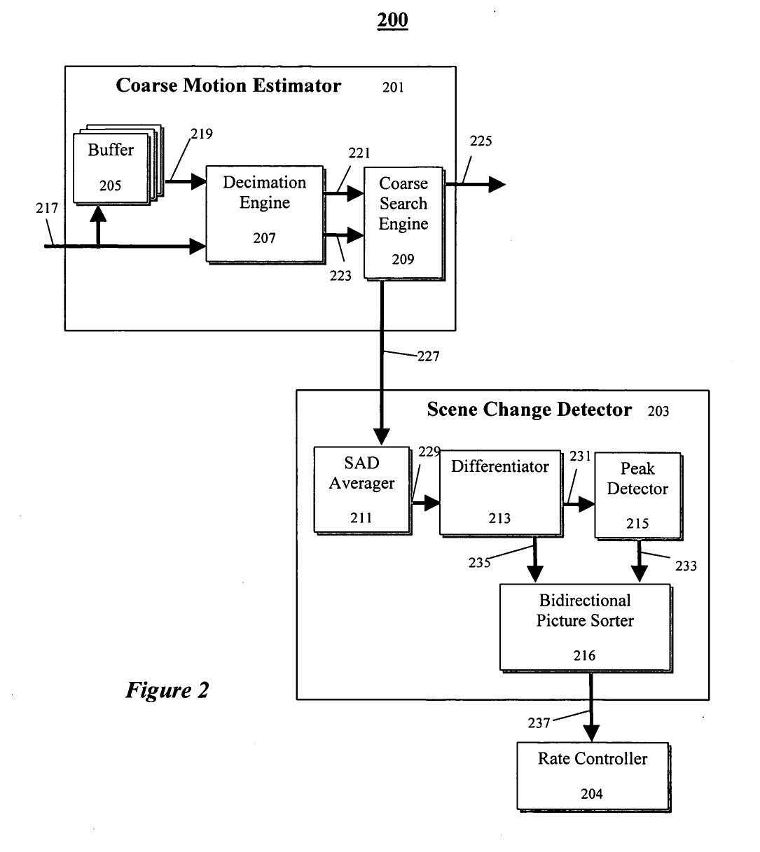

Referring now to FIG. 2, a block diagram of an exemplary system 200 with a scene change detector 203 is shown. The system 200 comprises a coarse motion estimator 201, the rate estimator 203, a rate controller 204.

The coarse motion estimator 201 further comprises a buffer 205, a decimation engine 207, and a coarse search engine 209.

The coarse motion estimator 201 can store one or more original pictures 217 in a buffer 205. By using only original pictures 217 for prediction, the coarse motion estimator 201 can process picture prior to encoding.

The decimation engine 207 receives the current picture 217 and one or more buffered pictures 219. The decimation engine 207 produces a sub-sampled current picture 223 and one or more sub-sampled reference pictures 221. The decimation engine 207 can sub-sample frames using a 2×2 pixel average. Typically, the coarse motion estimator 201 operates on macroblocks of size 16×16. After sub-sampling, the size is 8×8 for the luma grid and 4×4 for the chroma grids. For MPEG-2, fields of size 16×8 can be sub-sampled in the horizontal direction, so a 16×8 field partition could be evaluated as size 8×8.

The coarse motion estimator 201 search can be exhaustive. The coarse search engine 209 determines a cost 227 for motion vectors 225 that describe the displacement from a section of a sub-sampled current picture 223 to a partition in the sub-sampled buffered picture 221. For each search position in the sub-sampled current picture 223, an estimation metric or cost 227 can be calculated. The cost 227 can be based on a sum of absolute difference (SAD). One motion vector 225 for every partition can be selected and used for further motion estimation. The selection is based on cost.

Coarse motion estimation can be limited to the search of large partitions (e.g. 16×16 or 16×8) to reduce the occurrence of spurious motion vectors that arise from an exhaustive search of small block sizes.

The scene change detector 203 comprises a SAD averager 211, a differentiator 213, a peak detector 215, and a bidirectional picture sorter 216. The SAD values 227 from each macroblock are averaged in the SAD averager 211. The number of SAD values 227 averaged depends on the type of picture. A standard definition picture can be 720×480 pixels and contain 3,600 macroblocks. A high definition picture can be 1920×1088 pixels and contain 8,160 macroblocks.

The average SAD values 229 for each picture can be compared in the differentiator 213. A difference 231 between average SAD values 229 of adjacent pictures can be monitored in the peak detector 215. When the difference 231 exceeds a threshold, the peak detector can declare a scene change at 233. The scene change threshold can be predetermined empirically by measuring the average SAD during video sequences known to contain scene changes.

When bidirectionally coded pictures are in a video sequence, the video encoder will typically encode them following the pictures on which they depend. After the peak detector 215 declares the scene change 233, the bidirectional picture sorter 216 can improve the accuracy of the scene change 233. The bidirectionally coded picture can be predicted from a past picture and from a future picture. These SAD values 229 are passed to the differentiator 213. The difference 235 between the SAD values 229 is sent to the bidirectional picture sorter 216. If the SAD corresponding to the past picture were less than the SAD corresponding to the future picture, the bidirectionally coded picture would belong to the old scene. Conversely if the SAD corresponding to the past picture were greater than the SAD corresponding to the future picture, the bidirectionally coded picture would belong to the new scene.

The rate controller 204 uses the scene change location 237 that can be estimated to the nearest picture. The rate controller 204 can allocate an appropriate number of bits based on a priori scene change detection.

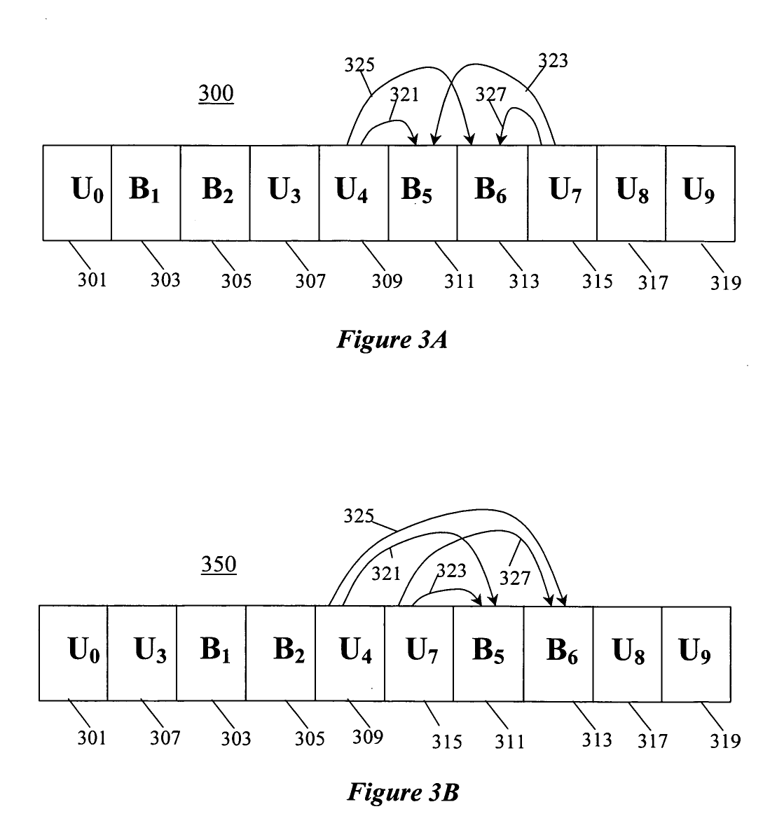

Referring now to FIG. 3A. The display order 300 of a video sequence is given. Some pictures 301, 307, 309, 315, 317, and 319 are unidirectionally predicted, and other pictures 303, 305, 311, and 313 are bidirectionally predicted. Picture B₅ 311 can be predicted in a forward direction 321 by picture U₄ 309 and in a reverse direction 323 by picture U₇ 315. Similarly, picture B₆ 313 can be predicted in a forward direction 325 by picture U₄ 309 and in a reverse direction 327 by picture U₇ 315.

Since bidirectional prediction is used, the video sequence 300 is reordered by the video encoder as shown in FIG. 3B. The reordered sequence 350 allows reference pictures 307 and 315, on which bidirectional pictures 303, 305, 311, and 313 can depend, to be processed earlier.

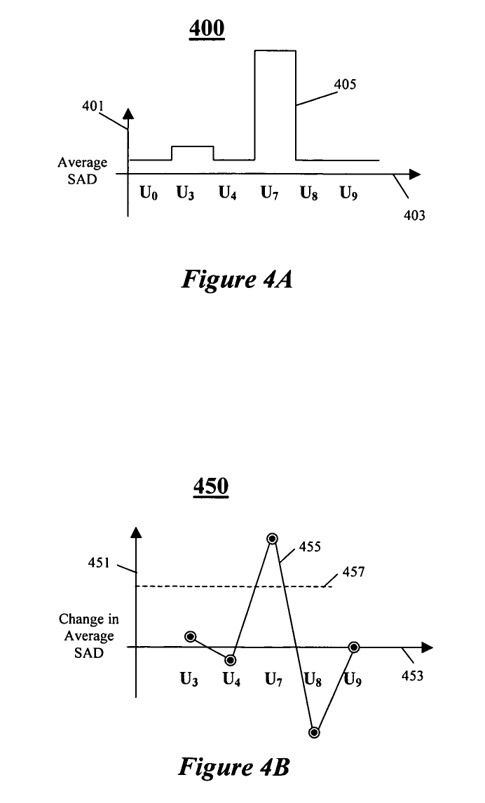

An initial search for a scene change can begin without considering bidirectional pictures. Referring now to FIG. 4A. An example progression 405 of average SAD 401 over unidirectional pictures 403 is shown.

In FIG. 4B, a progression 455 of a change in average SAD 451 over the same unidirectional pictures 453 is shown. By exceeding a threshold 457, a scene change is detected to be prior to picture U₇.

Referring back to FIG. 3B, the scene change is initially detected prior to picture U₇ 315. Since picture U₇ 315 was reordered to accommodate bidirectional picture B₅ 311 and picture B₆ 313, the scene change may have occurred before, between, or after picture B₅ 311 and picture B₆ 313.

Picture B₅ 311 and picture B₆ 313 can be classified as belonging to an old scene or a new scene by comparing the SAD from forward prediction to the SAD from reverse prediction. For example, picture B₅ 311 can be predicted in a forward direction 321 by picture U₄ 309 and in a reverse direction 323 by picture U₇ 315. If the SAD corresponding to the forward direction 321 were less than the SAD corresponding to the reverse direction 323, picture B₅ 311 would belong to the old scene. Conversely if the SAD corresponding to the forward direction 321 were greater than the SAD corresponding to the reverse direction 323, picture B₅ 311 would belong to the new scene.

This invention can be applied to video data encoded with a wide variety of standards, one of which is H.264. An overview of H.264 will now be given. A description of an exemplary system for scene change detection in H.264 will also be given.

H.264 Video Coding Standard

The ITU-T Video Coding Experts Group (VCEG) and the ISO/IEC Moving Picture Experts Group (MPEG) drafted a video coding standard titled ITU-T Recommendation H.264 and ISO/IEC MPEG-4 Advanced Video Coding, which is incorporated herein by reference for all purposes. In the H.264 standard, video is encoded on a macroblock-by-macroblock basis. The generic term “picture” refers to frames and fields.

The specific algorithms used for video encoding and compression form a video-coding layer (VCL), and the protocol for transmitting the VCL is called the Network Access Layer (NAL). The H.264 standard allows a clean interface between the signal processing technology of the VCL and the transport-oriented mechanisms of the NAL, so source-based encoding is unnecessary in networks that may employ multiple standards.

By using the H.264 compression standard, video can be compressed while preserving image quality through a combination of spatial, temporal, and spectral compression techniques. To achieve a given Quality of Service (QoS) within a small data bandwidth, video compression systems exploit the redundancies in video sources to de-correlate spatial, temporal, and spectral sample dependencies. Statistical redundancies that remain embedded in the video stream are distinguished through higher order correlations via entropy coders. Advanced entropy coders can take advantage of context modeling to adapt to changes in the source and achieve better compaction.

An H.264 encoder can generate three types of coded pictures: Intra-coded (I), Predictive (P), and Bidirectional (B) pictures. Each macroblock in an I picture is encoded independently of other pictures based on a transformation, quantization, and entropy coding. I pictures are referenced during the encoding of other picture types and are coded with the least amount of compression. Each macroblock in a P picture includes motion compensation with respect to another picture. Each macroblock in a B picture is interpolated and uses two reference pictures. The picture type I uses the exploitation of spatial redundancies while types P and B use exploitations of both spatial and temporal redundancies. Typically, I pictures require more bits than P pictures, and P pictures require more bits than B pictures.

For the purpose of scene detection I pictures and P pictures can both be considered unidirectional pictures. Although I pictures may not ultimately be coded based on motion estimation, the processing of motion estimation SAD for an I picture can enable scene change detection to include a scene boundary near the I picture.

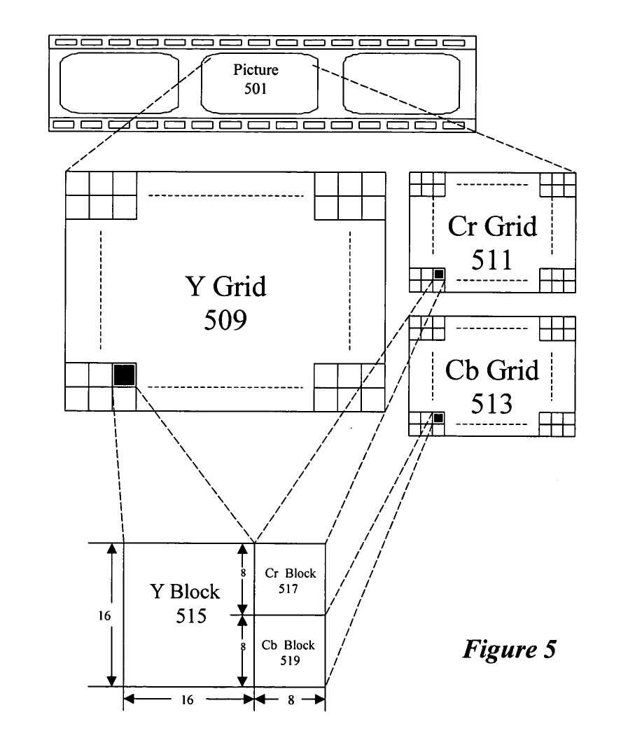

In FIG. 5 there is illustrated a block diagram of an exemplary picture 501. The picture 501 comprises two-dimensional grid(s) of pixels. For color video, each color component is associated with a unique two-dimensional grid of pixels. For example, a picture can include luma, chroma red, and chroma blue components. Accordingly, these components are associated with a luma grid 509, a chroma red grid 511, and a chroma blue grid 513. When the grids 509, 511, 513 are overlaid on a display device, the result is a picture of the field of view at the duration that the picture was captured.

Generally, the human eye is more perceptive to the luma characteristics of video, compared to the chroma red and chroma blue characteristics. Accordingly, there are more pixels in the luma grid 509 compared to the chroma red grid 511 and the chroma blue grid 513. In the H.264 standard, the chroma red grid 511 and the chroma blue grid 513 have half as many pixels as the luma grid 509 in each direction. Therefore, the chroma red grid 511 and the chroma blue grid 513 each have one quarter as many total pixels as the luma grid 509.

The luma grid 509 can be divided into 16×16 pixel blocks. For a luma block 515, there is a corresponding 8×8 chroma red block 517 in the chroma red grid 511 and a corresponding 8×8 chroma blue block 519 in the chroma blue grid 513. Blocks 515, 517, and 519 are collectively known as a macroblock that can be part of a slice group. Currently, sub-sampling is the only color space used in the H.264 specification. This means, a macroblock consist of a 16×16 luminance block 515 and two (sub-sampled) 8×8 chrominance blocks 517 and 518.

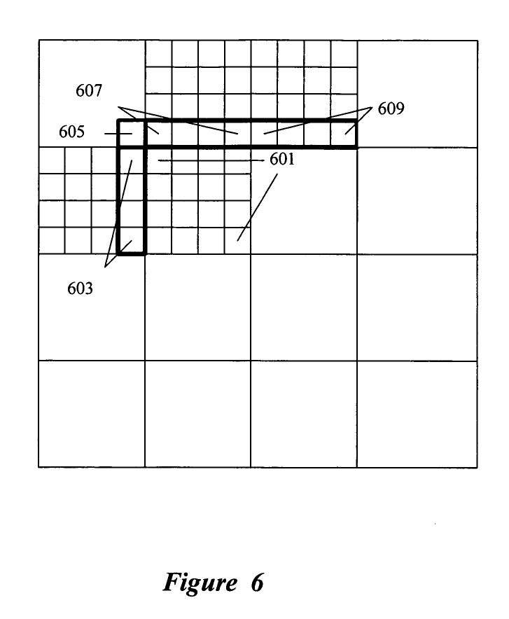

Referring now to FIG. 6, there is illustrated a block diagram describing spatially encoded macroblocks. Spatial prediction, also referred to as intra-prediction, involves prediction of picture pixels from neighboring pixels. The pixels of a macroblock can be predicted, in a 16×16 mode, an 8×8 mode, or a 4×4 mode. A macroblock is encoded as the combination of the prediction errors representing its partitions.

In the 4×4 mode, a macroblock 601 is divided into 4×4 partitions. The 4×4 partitions of the macroblock 601 are predicted from a combination of left edge partitions 603, a corner partition 605, top edge partitions 607, and top right partitions 609. The difference between the macroblock 601 and prediction pixels in the partitions 603, 605, 607, and 609 is known as the prediction error. The prediction error is encoded along with an identification of the prediction pixels and prediction mode.

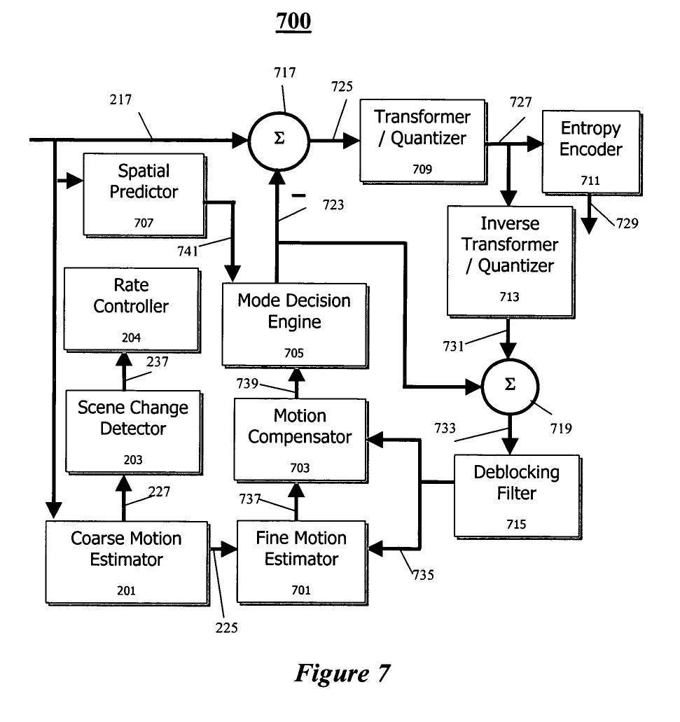

Referring now to FIG. 7, there is illustrated a block diagram of an exemplary video encoder 700. The video encoder 700 comprises a fine motion estimator 701, a coarse motion estimator 201, a motion compensator 703, a mode decision engine 705, a spatial predictor 707, a scene change detector 203, a rate controller 204, a transformer/quantizer 709, an entropy encoder 711, an inverse transformer/quantizer 713, and a deblocking filter 715.

The spatial predictor 707 uses only the contents of a current picture 217 for prediction. The spatial predictor 707 receives the current picture 217 and can produce a spatial prediction 741.

Spatially predicted partitions are intra-coded. Luma macroblocks can be divided into 4×4 or 16×16 partitions and chroma macroblocks can be divided into 8×8 partitions. 16×16 and 8×8 partitions each have 4 possible prediction modes, and 4×4 partitions have 9 possible prediction modes.

In the coarse motion estimator 201, the partitions in the current picture 217 are estimated from other original pictures. The other original pictures may be temporally located before or after the current picture 217, and the other original pictures may be adjacent to the current picture 217 or more than a frame away from the current picture 217. To predict a target search area, the coarse motion estimator 201 can compare large partitions that have been sub-sampled. The coarse motion estimator 201 will output an estimation metric 227 and a coarse motion vector 225 for each partition searched.

The fine motion estimator 701 predicts the partitions in the current picture 217 from reference partitions 735 using the set of coarse motion vectors 225 to define a target search area. A temporally encoded macroblock can be divided into 16×8, 8×16, 8×8, 4×8, 8×4, or 4×4 partitions. Each partition of a 16×16 macroblock is compared to one or more prediction blocks in previously encoded picture 735 that may be temporally located before or after the current picture 217.

The fine motion estimator 701 improves the accuracy of the coarse motion vectors 225 by searching partitions of variable size that have not been sub-sampled. The fine motion estimator 701 can also use reconstructed reference pictures 735 for prediction. Interpolation can be used to increase accuracy of a set of fine motion vectors 737 to a quarter of a sample distance. The prediction values at half-sample positions can be obtained by applying a 6-tap FIR filter or a bilinear interpolator, and prediction values at quarter-sample positions can be generated by averaging samples at the integer- and half-sample positions. In cases where the motion vector points to an integer-sample position, no interpolation is required.

The motion compensator 703 receives the fine motion vectors 737 and generates a temporal prediction 739. Motion compensation runs along with the main encoding loop to allow intra-prediction macroblock pipelining.

The estimation metric 227 is used to enable the scene change detector 203 to communicate a scene change 233 to the rate controller 204 as described with reference to FIG. 2.

The mode decision engine 705 will receive the spatial prediction 741 and temporal prediction 739 and select the prediction mode according to a sum of absolute transformed difference (SATD) cost that optimizes rate and distortion. A selected prediction 723 is output.

Once the mode is selected, a corresponding prediction error 725 is the difference 717 between the current picture 721 and the selected prediction 723. The transformer/quantizer 709 transforms the prediction error and produces quantized transform coefficients 727. In H.264, there are 52 quantization parameters.

Transformation in H.264 utilizes Adaptive Block-size Transforms (ABT). The block size used for transform coding of the prediction error 725 corresponds to the block size used for prediction. The prediction error is transformed independently of the block mode by means of a low-complexity 4×4 matrix that together with an appropriate scaling in the quantization stage approximates the 4×4 Discrete Cosine Transform (DCT). The Transform is applied in both horizontal and vertical directions. When a macroblock is encoded as intra 16×16, the DC coefficients of all 16 4×4 blocks are further transformed with a 4×4 Hardamard Transform.

H.264 specifies two types of entropy coding: Context-based Adaptive Binary Arithmetic Coding (CABAC) and Context-based Adaptive Variable-Length Coding (CAVLC). The entropy encoder 711 receives the quantized transform coefficients 727 and produces a video output 729. In the case of temporal prediction, a set of picture reference indices may be entropy encoded as well.

The quantized transform coefficients 727 are also fed into an inverse transformer/quantizer 713 to produce a regenerated error 731. The original prediction 723 and the regenerated error 731 are summed 719 to regenerate a reference picture 733 that is passed through the deblocking filter 715 and used for motion estimation.

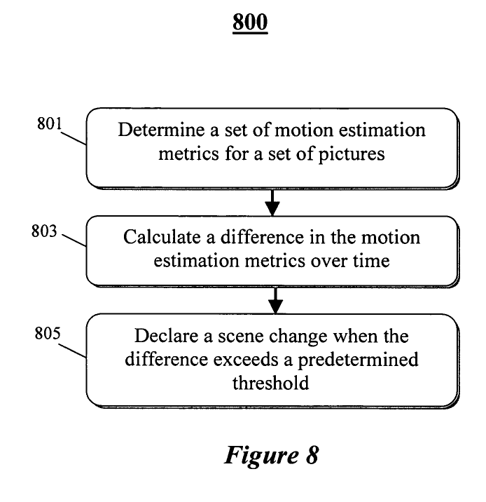

FIG. 8 is a flow diagram 800 of an exemplary method for scene change detection in accordance with an embodiment of the present invention. Determine a set of motion estimation metrics for a set of pictures at 801. The set of pictures may be those pictures that are intra-coded or inter-coded based on previous pictures. Bidirectionally coded pictures, that may be reordered during encoding, are considered after the pictures that are not bidirectionally coded. There is a one-to-one correspondence between motion estimation metrics and pictures in the set of pictures. The motion estimation metric for a picture may be the average sum of absolute difference (SAD). A motion estimator can generate a SAD for each macroblock in the picture, and these SAD values can then be averaged.

Calculate a difference in the motion estimation metrics over time at 803. The actual value of the average SAD may vary based on scene complexity and rate of motion. When the scene changes, the difference in the average SAD from one picture to the next can be more apparent than the average SAD taken individually.

Declare a scene change when the difference exceeds a predetermined threshold at 805. The threshold can be determined theoretically or empirically by measuring average SAD for one or more video sequences known to have a scene change.

When bidirectionally coded pictures are in a video sequence, the video encoder will typically encode them following the pictures on which they depend. After the scene change is declared based on the set of pictures that are not bidirectionally coded, the accuracy of the scene change can be improved by comparing motion estimation metrics corresponding to a picture that is bidirectionally coded. The bidirectionally coded picture can be predicted from a past picture and from a future picture. If the SAD corresponding to the past picture were less than the SAD corresponding to the future picture, the bidirectionally coded picture would belong to the old scene. Conversely if the SAD corresponding to the past picture were greater than the SAD corresponding to the future picture, the bidirectionally coded picture would belong to the new scene.

The embodiments described herein may be implemented as a board level product, as a single chip, application specific integrated circuit (ASIC), or with varying levels of a video classification circuit integrated with other portions of the system as separate components. An integrated circuit may store a supplemental unit in memory and use an arithmetic logic to encode, detect, and format the video output.

The degree of integration of the video classification circuit will primarily be determined by the speed and cost considerations. Because of the sophisticated nature of modern processors, it is possible to utilize a commercially available processor, which may be implemented external to an ASIC implementation.

If the processor is available as an ASIC core or logic block, then the commercially available processor can be implemented as part of an ASIC device wherein certain functions can be implemented in firmware as instructions stored in a memory. Alternatively, the functions can be implemented as hardware accelerator units controlled by the processor.

While the present invention has been described with reference to certain embodiments, it will be understood by those skilled in the art that various changes may be made and equivalents may be substituted without departing from the scope of the present invention.

Additionally, many modifications may be made to adapt a particular situation or material to the teachings of the present invention without departing from its scope. For example, although the invention has been described with a particular emphasis on one encoding standard, the invention can be applied to a wide variety of standards.

Therefore, it is intended that the present invention not be limited to the particular embodiment disclosed, but that the present invention will include all embodiments falling within the scope of the appended claims.

1. A method for detecting a scene change, said method comprising:
measuring differences between a first picture and a second picture;
measuring differences between the second picture and a third picture;
measuring the deviation between the measured differences between the first picture and the second picture, and the measured differences between the second picture and third picture; and
declaring a scene change wherein the measured deviation exceeds a predetermined threshold.

2. The method of claim 1, wherein measuring the differences between the first picture and the second picture further comprises:
determining a first set of motion estimation metrics for the first picture and the second picture.

3. The method of claim 2, wherein measuring the differences between the second picture and the third picture further comprises:
determining a second set of motion estimation metrics for the second picture and the third picture.

4. The method of claim 3, wherein measuring the deviation between the measured differences further comprises:
calculating a difference between the first set of motion estimation metrics and the second set of motion estimation metrics.

5. The method of claim 3, wherein determining the first set of motion estimation metrics further comprises:
generating a sum of absolute differences for each macroblock in the first picture or second picture.

6. The method of claim 5, further comprising:
averaging the sums of absolute differences for each of the macroblocks in the first picture or second picture.

7. A method for scene change detection in a video encoder, said method comprising:
determining a set of motion estimation metrics for a set of pictures;
calculating a difference in the motion estimation metrics over time; and
declaring a scene change where the difference exceeds a predetermined threshold.

8. The method of claim 7, wherein a motion estimation metric for a current picture is based on a previous picture.

9. The method of claim 7, wherein determining a set of motion estimation metrics further comprises:
generating a sum of absolute difference for each macroblock in a picture in the set of pictures.

10. The method of claim 7, wherein the method further comprises:
allocating a larger number of bits to a picture encoded after the scene change.

11. The method of claim 7, wherein a current picture is associated with a motion estimation metric based on a previous picture and a motion estimation metric based on a future picture.

12. The method of claim 11, wherein the method further comprises:
adjusting the scene change based on the difference between the motion estimation metric based on the previous picture and the motion estimation metric based on the future picture.

13. A system for rate estimation in a video encoder, said method comprising:
a motion estimator for:
determining differences between a first picture and a second picture; and
determining differences between a second picture and a third picture;
a differentiator for measuring the deviation between the measured differences between the first picture and the second picture, and the measured differences between the second picture and third picture; and
a peak detector for declaring a scene change wherein the measured deviation exceeds a predetermined threshold.

14. The system of claim 13, wherein a set of motion estimation metrics comprises the measured differences between the first picture and the second picture and the measured differences between the second picture and the third picture.

15. The system of claim 13, wherein the motion estimator further comprises:
a search engine for generating a sum of absolute difference for each macroblock in a picture; and
a SAD averager for averaging the sums of absolute difference for each macroblock in the picture, thereby producing a motion estimation metric in the set of motion estimation metrics.

16. The system of claim 13, wherein the system further comprises:
a rate controller for allocating a larger number of bits to a picture encoded after the scene change.

17. The system of claim 13, wherein a current picture is associated with a motion estimation metric based on a previous picture and a motion estimation metric based on a future picture.

18. The system of claim 17, wherein the system further comprises:
a bidirectional picture sorter for adjusting the scene change based on the difference between the motion estimation metric based on the previous picture and the motion estimation metric based on the future picture.

19. A system comprising:
an integrated circuit for determining a difference in a set of motion estimation metrics and declaring a scene change where the difference exceeds a threshold, wherein one motion estimation metric in the set of motion estimation metrics corresponds to one pictures.

20. The system of claim 19, wherein a motion estimation metric for a current picture is based on a previous picture.

21. The system of claim 19, wherein a motion estimation metric in the set of motion estimation metrics is an average of a sum of absolute difference.

22. The system of claim 19, wherein the integrated circuit further allocates a larger number of bits to a picture encoded after the scene change.

23. The system of claim 19, wherein a current picture is associated with a first metric and a second metric, wherein the first metric is a motion estimation metric based on a previous picture and the second metric is a motion estimation metric based on a future picture.

24. The system of claim 19, wherein the integrated circuit further adjusts the scene change based on the difference between the first metric and the second metric.
